(19) United States
(12) Patent Application Publication
(10) Pub. No.: US 2012/0276476 A1
(43) Pub. Date: Nov. 1, 2012

(54) TONER FOR ELECTROSTATIC USE

(75) Inventors: Jae Bum Park, Daejeon-city (KR); Young Jae Kwon, Daejeon-city (KR)

(73) Assignee: SAMSUNG FINE CHEMICALS CO., LTD., Ulsan (KR)

(21) Appl. No.: 13/508,506

(22) PCT Filed: Dec. 16, 2010
(86) PCT No.: PCT/KR2010/009033

§ 371 Date: May 7, 2012

(30) Foreign Application Priority Data
Dec. 16, 2009 (KR) 10-2009-0125686

(51) Int. Cl. G03G 9/087; G03G 13/08

(52) U.S. Cl. 430/109.1; 430/123.5

(57) ABSTRACT

Toner particles having high transcription efficiency and reducing toner toner consumption. The toner includes a binder resin and a colorant, wherein a particle diameter distribution of the toner particles satisfy the following conditions:

GSDα≦GSDβ≦GSDγ (1)

0.80≦GSDβ≦0.88 (2)

### TECHNICAL FIELD

The present invention relates to toner particles for developing an electrostatic image, a developer for forming an electrophotographic image including the same, and a method of forming an electrophotographic image using the developer, and more particularly, to toner particles having a narrow particle diameter distribution and high transfer efficiency, and reduces toner consumption, a developer for forming an to electrophotographic image including the same, and a method of forming an electrophotographic image using the developer.

### BACKGROUND ART

A variety of electrophotographic printing systems have been reported. By using is an electrophotogarphic printing system, an electrostatic latent image is formed on a photoreceptor using a photoconductive material via various methods, the electrostatic latent image is developed by supplying toner thereto to form a visual toner image, the toner image is transferred onto a transfer image-receiving medium such as paper, and the toner image is fixed on the medium by applying heat and/or pressure thereto.

Image forming apparatuses using electrophotography include printers, facsimiles, and the like. The image forming apparatuses require to have high resolution and excellent clearness. For this, toner having a small particle diameter is currently being developed.

Meanwhile, if toner particle diameter is widely distributed, a photoreceptor may be contaminated or cleaning properties may deteriorate.

Recently, a need for toner suitable for a high-speed printing, particularly toner having high transcription efficiency and reducing toner consumption increases in the printing industry.

### DETAILED DESCRIPTION OF THE INVENTION

### Technical Problem

The present invention provides toner particles having high transfer efficiency and excellent cleaning properties, and reducing toner consumption.

The present invention also provides a developer for an electrostatic image including the toner particles.

The present invention also provides a method of forming an electrophotographic image using the developer for an electrostatic image.

### Technical Solution

According to an aspect of the present invention, there is provided toner particles including a binder resin and a colorant, wherein a particle diameter distribution of the toner particles satisfy the following conditions:

$$\begin{matrix}{GSD}_{α} \leq {GSD}_{β} \leq {GSD}_{γ} & ( 1 ) \\ 0.80 \leq {GSD}_{β} \leq 0.88 \\ {GSD}_{α} = \frac{{D}_{16 , Number}}{{D}_{16 , Volume}} \\ where \\ {GSD}_{β} = \frac{{D}_{50 , Number}}{{D}_{50 , Volume}} ; \\ and \\ {GSD}_{γ} = \frac{{D}_{84 , Number}}{{D}_{84 , Volume}} , & ( 2 )\end{matrix}$$

wherein D_{16, Number} and D_{16, Volume} respectively refer to a cumulative 16% number particle diameter from the smallest number particle diameter and a cumulative 16% volume particle diameter from the smallest volume particle diameter;

D_{50, Number} and D_{50, Volume} respectively refer to a 50% number particle diameter and a 50% volume particle diameter;

D_{84, Number} and D_{84, Volume} respectively refer to a cumulative 84% number particle diameter from the smallest number particle diameter and a cumulative 84% volume particle diameter from the smallest volume particle diameter.

GSD_{α}>0.5.

GSD_{γ}≦1.

According to an aspect of the present invention, there is provided a developer for an electrostatic image including toner particles.

According to an aspect of the present invention, there is provided a method of forming an electrophotographic image, the method including forming a toner image by adhering toner to a photoreceptor on which an electrostatic image is formed, and transferring the toner image to a transferring medium.

### Advantageous Effects

Toner particles according to embodiments of the present invention have high transfer efficiency and excellent cleaning properties, and reduce toner consumption.

### BEST MODE FOR CARRYING OUT THE INVENTION

Hereinafter, the present invention will now be described more fully with reference to the accompanying drawings, in which exemplary embodiments of the invention are shown.

Hereinafter, toner particles according to exemplary embodiments of the present invention will be described in detail. As used herein, the term “and/or” includes any and all combinations of one or more of the associated listed items. Expressions such as “at least one of,” when preceding a list of elements, modify the entire list of elements and do not modify the individual elements of the list.

Toner particles according to an embodiment of the present invention include a binder resin and a colorant, wherein a particle diameter distribution of the toner particles satisfy the following conditions:

$$\begin{matrix}{GSD}_{α} \leq {GSD}_{β} \leq {GSD}_{γ} & ( 1 ) \\ 0.80 \leq {GSD}_{β} \leq 0.88 \\ {GSD}_{α} = \frac{{D}_{16 , Number}}{{D}_{16 , Volume}} , \\ where \\ {GSD}_{β} = \frac{{D}_{50 , Number}}{{D}_{50 , Volume}} ; \\ and \\ {GSD}_{γ} = \frac{{D}_{84 , Number}}{{D}_{84 , Volume}} , & ( 2 )\end{matrix}$$

In this regard, D_{16, Number} and D_{16, Volume} respectively refer to a cumulative 16% number particle diameter from the smallest number particle diameter and a cumulative 16% volume particle diameter from the smallest volume particle diameter.

D_{50, Number} and D_{50, Volume} respectively refer to a 50% number particle diameter and a 50% volume particle diameter.

D_{84, Number} and D_{84, Volume} respectively refer to a cumulative 84% number particle diameter from the smallest number particle diameter and a cumulative 84% volume particle diameter from the smallest volume particle diameter.

Toner particles according to an embodiment of the present invention have a narrow particle diameter distribution and high transfer efficiency, and reduce toner consumption since the toner particles satisfy the above conditions.

According to an embodiment of the present invention, GSD_{α}>0.5.

According to another embodiment of the present invention, GSD_{γ}≦1.

The binder resin contained in the toner particles according to the current embodiment may be prepared by polymerizing at least one polymerizable monomer selected from the group consisting of a vinyl-based monomer, a polar monomer having a carboxy group, a monomer having an unsaturated ester group, and a monomer having a fatty acid group. The polymerizable monomer may include at least one monomer selected from the group consisting of styrene-based monomers such as styrene, vinyl toluene, and α-methyl styrene; acrylic acid or methacrylic acid; derivatives of (meth) acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and metacryl amide; ethylenically unsaturated mono-olefins such as ethylene, propylene, and butylenes; halogenated vinyls such as vinyl chloride, vinylidene chloride, and vinyl fluoride; vinyl esters such as vinyl acetate and vinyl propionate; vinyl ethers such as vinyl methyl ether and vinyl ethyl ether; vinyl ketones such as vinyl methyl ketone and methyl isoprophenyl ketone; and nitrogen-containing vinyl compounds such as 2-vinylpyridine, 4-vinylpyridine, and N-vinyl pyrrolidone, but is not limited thereto.

Generally, a polymerization initiator may be used to initiate the polymerization. Examples of the polymerization initiator are a benzoyl peroxide-based polymerization initiator and an azo-based polymerization initiator.

A portion of the binder resin may be subjected to a reaction with a cross-linking agent, such as an isocyanate compound and an epoxy compound.

The colorant contained in the toner particles may be used in the form of a pigment itself, or alternatively, in the form of a pigment master batch in which the pigment is dispersed in a resin.

The pigment may be selected from pigments that are commonly and commercially used, such as a black pigment, a cyan pigment, a magenta pigment, a yellow pigment and a mixture thereof.

The amount of the colorant may be sufficient to color the toner and form a visible image by development, for example, in the range of 1 to 20 parts by weight based on 100 parts by weight of the binder resin.

Meanwhile, the toner particles may further include additives in addition to the binder resin and the colorant. The additives may include a releasing agent such as wax, a charge control agent, or the like.

Wax improves fixing properties of a toner image. Examples of the wax include polyalkylene wax such as low molecular weight polypropylene and low molecular weight polyethylene, ester wax, carnauba wax, and paraffin wax. The amount of the wax contained in toner may be in a range of about 0.1 parts by weight to about 30 parts by weight based on 100 parts by weight of the entire toner composition. If the amount of the wax is less than 0.1 parts by weight, oilless fixing of toner particles in which toner particles are fixed without using oil cannot be performed. On the other hand, if the amount of the wax is greater than 30 parts by weight, toner may be flocculated while it is stored.

The additives may further include external additives. The external additives are used to improve fluidity of the toner or control charge properties of the toner. Examples of the external additives include large particulate silica, small particulate silica, and polymer beads.

The toner particles according to the current embodiment may be prepared by using various methods. In other words, any method of preparing toner particles having the above-mentioned properties which is commonly used in the art may be used.

For example, the toner particles may be prepared by using the following method. A coagulant is added to a mixture including a latex dispersion, a colorant dispersion, and a wax dispersion. Then, the mixture is homogenized and aggregated to prepare toner particles. That is, the latex dispersion, the colorant dispersion, and the wax dispersion are added to a reactor and mixed. Then, the coagulant is added thereto, and the mixture is homogenized at a stirring line speed of 1.0 to 2.0 m/s at a temperature of 20 to 30° C. for 10 to 100 minutes while controlling the pH in the range of 1.5 to 2.3. Then, the reactor is heated to a temperature in the range of 48 to 53° C. and stirred at a stirring line speed of 1.0 to 2.5 m/s to perform aggregation.

The aggregated particles are fused, cooled, and dried to obtain desired toner particles. The dried toner particles are treated with external additives using, for example, silica, and a charge quantity thereof is adjusted to obtain desired toner for a laser printer.

The toner particles according to the current embodiment may have a core-shell structure. The toner having the core-shell structure may be prepared by using a method including: preparing a primary aggregated toner by adding a coagulant into a mixture of a latex dispersion for a core, a colorant dispersion, and a wax dispersion, and homogenizing and aggregating the mixture; forming a shell by adding a latex for a shell to the primary aggregated toner; and fusing the structure.

According to another embodiment of the present invention, a developer for an electrostatic image including the toner particles is provided. The developer for an electrostatic image may further include at least one carrier selected from the group consisting of ferrite coated with an insulating material, magnetite coated with an insulating material and iron powder coated with an insulating material.

According to another embodiment of the present invention, a method of forming an electrophotographic image using the toner particles is provided.

Particularly, the method includes forming a toner image by adhering the toner or the developer for an electrostatic image to a photoreceptor on which an electrostatic image is formed, and transferring the toner image to a transfer medium.

The toner or the developer for an electrostatic image according to the current embodiment is used in an apparatus for forming an electrophotograhic image. In this regard, the apparatus for forming an electrophotographic image includes laser printers, photocopiers, facsimiles, or the like.

Hereinafter, one or more embodiments will be described in detail with reference to the following examples. However, these examples are not intended to limit the purpose and scope of the invention.

Measurement of Average Particle Diameter

Average particle diameter of toner was measured using a Multisizer 3 Coulter Counter. An aperture of 100 μm was used in the Multisizer 3 Coulter Counter, an appropriate amount of a surfactant was added to 50 to 100 ml of ISOTON-II (Beckman Coulter Inc.) as an electrolyte, and 10 to 15 mg of a sample to be measured was added thereto, and the resultant was dispersed in a ultrasonic dispersing apparatus for 5 to minutes to prepare a sample.

Measurement of Glass Transition Temperature (Tg, ° C.)

A glass transition temperature (Tg) of a sample was measured using a differential scanning calorimeter (DSC, manufactured by Netzsch Co.) by heating the sample from 20 to 200° C. at 10° C./min, rapidly cooling the sample to 10° C. at 20° C./min, and heating the sample at 10° C./min.

Acid Value

An acid value (mgKOH/g) was measured by dissolving a resin in dichloromethane, cooling the solution and titrating the solution with 0.1 N KOH methyl alcohol solution.

Molecular Weight

A Molecular weight was measured by using a gel permeation chromatography (Waters Alliance GPC 2000 systems). Tetrahydrofuran (THF) was used as a solvent, and a calibration curve was obtained by using standard polystyrene.

### EXAMPLE 1

Preparation of Latex for Core and Shell

A 30 L reactor equipped with a stirrer, a thermometer, and a condenser was installed in an oil bath in which the oil is a heat transfer medium. 6,600 g of distilled water and 32 g of a surfactant (Dowfax 2A1) were added to the reactor, and the reactor was heated to 70° C. and stirred at 100 rpm. Then, an emulsion mixture including monomers, i.e., 8,380 g of styrene, 3,220 g of butyl acrylate, 370 g of 2-carboxyethyl acrylate, and 226 g of 1,10-decanediol diacrylate, 5,075 g of distilled water, 226 g of the surfactant (Dowfax 2A1), 530 g of polyethylene glycol ethyl ether methacrylate, and 188 g of 1-dodecanethiol, as a chain transfer agent, was stirred at 400 to 500 rpm for 30 minutes using a disc-type impeller. Then, the emulsion mixture was gradually added to the reactor for 1 hour. The reactor was maintained for about 8 hours and gradually cooled to room temperature to complete the reaction.

The glass transition temperature (Tg) of the binder resin measured using a differential scanning calorimeter (DSC) was 62° C. The number average molecular weight of the binder resin measured by a gel permeation chromatography (GPC) using polystyrene as a standard sample was 50,000.

Preparation of Pigment Dispersion

540 g of a cyan pigment (Daicolor Pigment MFG. Co. Ltd., Japan, ECB303), 27 g of a surfactant (Dowfax 2A1), and 2,450 g of distilled water were added to a 3 L reactor equipped with a stirrer, a thermometer, and a condenser, and the reactor was slowly stirred for about 10 hours to obtain a pre-dispersion. The pre-dispersion was further dispersed using a beads mill (Netzsch, Germany, Zeta RS) for 4 hours. As a result, a cyan pigment dispersion was obtained.

Then, the particle diameter of the cyan pigment was measured using a Multisizer 2000 (Malvern Instruments, Ltd.), and D50(v) was 170 nm. In this regard, when the volume of the particles is accumulated from particles of the smallest size in ascending order until the cumulative volume reaches 50% of the total volume of the toner, an average particle size of the accumulated particles corresponding to 50% of the total volume of the particles is defined as D50(v).

Preparation of Wax Dispersion

65 g of a surfactant (Dowfax 2A1), and 1,935 g of distilled water were added to a 5 L reactor equipped with a stirrer, a thermometer, and a condenser, and 1,000 g of wax (NOF Corporation, Japan, WE-5) was added to the reactor while slowly stirring the reactor at a high temperature for about 2 hours. The wax was dispersed for 30 minutes using a homogenizer (IKA, T-45). As a result, a wax dispersion was obtained.

Then, the particle diameter of the wax was measured using a Multisizer 2000 (Malvern Instruments, Ltd.), and D50(v) was 320 nm.

Preparation Toner Particles

13,881 g of the latex dispersion for a core, 2,238 g of the colorant dispersion, and 2,873 g of the wax dispersion were added to a 70 L reactor, and the mixture was mixed at room temperature for about 15 minutes at 1.21 m/s. 5,760 g of a solution including poly silicato iron (PSI) and nitric acid (PSI/1.88% HNO₃=1/2), as a coagulant, was added to the reactor, and then the mixture was homogenized using a homogenizer (IKA, T-45) while stirring the reactor at 25° C. at 50 rpm (at a stirring line speed of 1.79 m/sec) for 30 minutes while controlling the pH in the range of 1.3 to 2.3. After the mixture was dispersed for 30 minutes, the reactor was heated to 51° C. and stirred at 2.42 m/s using a pitched paddle-type impeller having a diameter of 0.30 m and a height of 0.07 m until the D_{50,v} was in the range of 6.2 to 6.4 μm. Then, 5,398 g of a latex for a shell was added thereto for about 20 minutes. The reactor was stirred until an average particle diameter of the toner particles was in the range of 6.7 to 6.9 μm. A 4% sodium hydroxide aqueous solution was added to the reactor and the reactor was stirred at 1.90 m/s until the pH reached 4 and at 1.55 m/s until the pH reached 7. While maintaining the stirring speed, the reactor was heated to 96° C. to fuse the toner particles. When circularity measured using a FPIA-3000 (Sysmex, Japan) was 0.980, the reactor was cooled to 40° C., and the pH of the mixture was adjusted to 9.0. Then, the toner particles were isolated using a SUS sieve having a pore size of 16 μm and cleaned four times using distilled water. The pH of the toner particles was adjusted to 1.5 by using a 1.88% nitric acid aqueous solution and the toner particles were cleaned. The toner particles were cleaned four times with distilled water to remove a surfactant, or the like. Then, the cleaned toner particles were dried in a fluidized bed dryer at 40° C. for 5 hours to obtain dried toner particles.

### EXAMPLES 2 TO 3

Toner particles were prepared in the same manner as in Example 1, except that the size of the impeller and stirring rate were adjusted as shown in Table 1 below. In Table 1, d refers to a diameter of the impeller, and b refers to a height of the impeller. The stirring rates of Table 1 are expressed using percentages based on the stirring rate of Example 1.

### COMPARATIVE EXAMPLES 1 TO 3

Toner particles were prepared in the same manner as in Example 1, except that different types of impeller were used.

TABLE 1

| | | | | Comparative | Comparative | Comparative |
|---|---|---|---|---|---|---|
| | Example 1 | Example 2 | Example 3 | Example 1 | Example 2 | Example 3 |
| Size of impeller | d = 0.30 | d = 0.30 | d = 0.30 | Propeller-type | Dispersed type | Anchor-type |
| (meter) | b = 0.07 | b = 0.07 | b = 0.07 | | | |
| Stirring rate | 0% | −5% | +5% | 0% | 0% | 0% |

GSD_{α}, GSD_{β}, and GSD_{γ} of the toner particles prepared according to Examples 1 to 3 and Comparative Examples 1 to 3 are shown in Table 2 below.

TABLE 2

| | | | | Comparative | Comparative | Comparative |
|---|---|---|---|---|---|---|
| | Example 1 | Example 2 | Example 3 | Example 1 | Example 2 | Example 3 |
| GSD_{α} | 0.793 | 0.774 | 0.771 | 0.861 | 0.854 | 0.786 |
| GSD_{β} | 0.823 | 0.846 | 0.842 | 0.859 | 0.846 | 0.760 |
| GSD_{γ} | 0.862 | 0.863 | 0.861 | 0.879 | 0.864 | 0.677 |

Referring to Table 2, while the toner particles prepared according to an embodiment of the present invention satisfy the conditions (1) and (2), the toner particles prepared according to Comparative Examples 1 to 3 don't satisfy the conditions (1) and/or (2).

The toner particles prepared according to Examples 1 to 3 and Comparative Examples 1 to 3 were evaluated as follows.

Evaluation of Charging Properties

9.75 g of toner particles prepared in Examples 1 to 3 and Comparative Examples 1 to 3, 0.2 g of silica (TG 810G; Cabot Co.), and 0.05 g of silica (RX50; Degussa GmbH) were mixed to prepare a toner. Using the toner, charging properties were measured using a device for measuring charging properties (EPPING, Germany). 9.3 g of a carrier (100 μm, The Image Society of Japan) and 0.7 g of a mixture of the toner and silica were mixed using a Turbular mixer (WAB, Switzerland). Charge amount of 1 g of the mixture was measured at room temperature and humidity by using a q/m meter for 90 seconds, and the results are shown in Table 3 below.

Evaluation of Toner Consumption

9.75 g of toner particles prepared in any of Examples 1 to 3 and Comparative Examples 1 to 3, 0.2 g of silica (TG 810G; Cabot Co.) and 0.05 g of silica (RX50, Degussa GmbH) were mixed to prepare a toner. Using the toner, 1,000 pages of A4 paper having a letter image with 5% coverage were printed using a Samsung CLP-510 printer. Then, weights of toner remaining on the developer and waste toner were measured and compared with the weight of the developer before the printing. Toner consumption per 1,000 pages was calculated.

Toner consumption per 1,000 pages=(Weight of developer before printing)−[(Weight of developer after printing)−(Weight of waste toner after printing)]

Evaluation of Transfer Efficiency

9.75 g of toner particles prepared in any of Examples 1 to 3 and Comparative Examples 1 to 3, 0.2 g of silica (TG 810G; Cabot Co.) and 0.05 g of silica (RX50, Degussa GmbH) were mixed to prepare a toner. Using the toner, solid patterns of 2 cm×2 cm were transferred using a Samsung CLP-510 printer, and then weights of toner remaining OPC, an intermediate belt, and paper were measured. Transfer efficiency was evaluated using the measured weights according to the following equation.

Primary Transfer Efficiency(%)=[(Amount of toner remaining on intermediate transfer medium)/(amount of toner remaining on photoreceptor)]*100

Secondary Transfer Efficiency(%)=[(Amount of toner remaining on paper)/(amount of toner remaining on intermediate transfer medium)]*100

Evaluation of Image Quality

9.75 g of toner particles prepared in any of Examples 1 to 3 and Comparative Examples 1 to 3, 0.2 g of silica (TG 810G; Cabot Co.) and 0.05 g of silica (RX50, Degussa GmbH) were mixed to prepare a toner. Using the toner, ISO/JIS-SCID N2 images were printed using a Samsung CLP-510 printer and evaluated as follows.

◯: Details are clearly visible

Δ: Details are not clearly visible

×: Details are opaque

The results of the evaluation are shown in Table 3 below.

TABLE 3

| | | | | Comparative | Comparative | Comparative |
|---|---|---|---|---|---|---|
| | Example 1 | Example 2 | Example 3 | Example 1 | Example 2 | Example 3 |
| Charge amount | −50 | −51 | −55 | −30 | −35 | −33 |
| Toner | 45 | 48 | 47 | 55 | 61 | 58 |
| consumption (g) | | | | | | |
| Transfer | 95% | 93% | 96% | 90% | 88% | 85% |
| efficiency (%) | | | | | | |
| Image quality | Excellent | Excellent | Excellent | Back ground | Back ground | Back ground |
| | at 6K | at 6K | at 6K | occurs after 3K | occurs after 3K, | occurs after 3K, |
| | | | | | and printing stops | and printing stops |
| | | | | | after 3.5K due to | after 3.5K due to |
| | | | | | serious back ground. | serious back ground. |

As shown in Table 3, toner particles prepared in Examples 1 to 3 according to embodiments of the present invention have a narrow particle diameter distribution, excellent change properties, high transfer efficiency, and excellent image quality, and reduces toner consumption.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. Toner particles comprising a binder resin and a colorant, wherein a particle diameter distribution of the toner particles satisfy the following conditions:
$$\begin{matrix}{GSD}_{α} \leq {GSD}_{β} \leq {GSD}_{γ} & ( 1 ) \\ 0.80 \leq {GSD}_{β} \leq 0.88 \\ {GSD}_{α} = \frac{{D}_{16 , Number}}{{D}_{16 , Volume}} \\ where \\ {GSD}_{β} = \frac{{D}_{50 , Number}}{{D}_{50 , Volume}} ; \\ and \\ {GSD}_{γ} = \frac{{D}_{84 , Number}}{{D}_{84 , Volume}} , & ( 2 )\end{matrix}$$
wherein D_{16, Number} and D_{16, Volume} respectively refer to a cumulative 16% number particle diameter from the smallest number particle diameter and a cumulative 16% volume particle diameter from the smallest volume particle diameter;
D_{50, Number} and D_{50, Volume} respectively refer to a 50% number particle diameter and a 50% volume particle diameter;
D_{84, Number} and D_{84, Volume} respectively refer to a cumulative 84% number particle diameter from the smallest number particle diameter and a cumulative 84% volume particle diameter from the smallest volume particle diameter.

2. The toner particles of claim 1, wherein GSD_{α}>0.5.

3. The toner particles of claim 1, wherein GSD_{γ}≦1.

4. A developer for an electrostatic image comprising toner particles according to claim 1.

5. The developer of claim 4, wherein the developer for an electrostatic image comprises at least one carrier selected from the group consisting of ferrite coated with an insulating material, magnetite coated with an insulating material and iron powder coated with an insulating material.

6. A method of forming an electrophotographic image, the method comprising forming a toner image by adhering toner to a photoreceptor on which an electrostatic image is formed and transferring the toner image to a transferring medium, wherein the toner comprises toner particles according to claim 1.

7. A developer for an electrostatic image comprising toner particles according to claim 2.

8. A developer for an electrostatic image comprising toner particles according to claim 3.

9. A method of forming an electrophotographic image, the method comprising forming a toner image by adhering toner to a photoreceptor on which an electrostatic image is formed and transferring the toner image to a transferring medium, wherein the toner comprises toner particles according to claim 2.

10. A method of forming an electrophotographic image, the method comprising forming a toner image by adhering toner to a photoreceptor on which an electrostatic image is formed and transferring the toner image to a transferring medium, wherein the toner comprises toner particles according to claim 3.
